(19) United States
(12) Patent Application Publication
(10) Pub. No.: US 2011/0030225 A1
(43) Pub. Date: Feb. 10, 2011

(54) PRESS-DOWN TYPE COMPOSITE PUTTY KNIFE

(76) Inventor: Desheng WANG, Zhejiang (CN)

Correspondence Address: WANG Desheng;NO. 10, 2ND XITA ROAD, WEST OF CITY INDUSTRY AREA, YONGKANG, ZHEJIANG, CN

(21) Appl. No.: 12/538,179

(22) Filed: Aug. 10, 2009

(51) Int. Cl. B25G 3/02; A47L 17/06

(52) U.S. Cl. 30/340; 15/236.01

(57) ABSTRACT

A press-down type composite putty knife which comprises a handle and a blade with a rear end of the blade inserted into a blade receiving slot at a front end of the handle; the rear end of the blade has a blade tang which is provided with a fixing notch; a latch is disposed at the front end of the handle inside its casing; latch springs are disposed under the latch for returning the latch to its original position; a pressing part is formed by an upper end of the latch which extends outwardly from an upper surface of the handle; a longitudinal slot in communication with the blade receiving slot is disposed at a lower portion of the latch; a fixing block corresponding to the fixing notch of the blade tang is disposed on a bottom surface of the longitudinal slot. The engagement between the latch and the fixing notch allows the handle and the blade of the present invention to be removably assembled, and therefore fulfill the object of replacing blades of different specifications on the same handle. Cost of use will be lower accordingly and carrying the knives becomes more convenient.

### BACKGROUND OF THE INVENTION

The present invention relates to a hand tool for painting and construction, especially a press-down type composite putty knife.

A conventional putty knife usually has its blade fixedly connected with its handle. However, as putty knives of different widths should be used according to different construction situations, users have to carry a number of putty knives with them when they work outdoor. Carrying the knives is not only inconvenient, but also increases the cost of use.

### BRIEF SUMMARY OF THE INVENTION

In view of the disadvantages now present in the prior art, the present invention provides a press-down type composite putty knife that allows blades of different specifications to be replaced on the same handle, thereby lowering the cost of use and bringing greater convenience for users to carry the knife.

To attain this, the present invention adopts the following technical proposals:

A press-down type composite putty knife which comprises a handle and a blade with a rear end of the blade inserted into a blade receiving slot at a front end of the handle; the rear end of the blade has a blade tang which is provided with a fixing notch; a latch is disposed at the front end of the handle inside its casing; latch springs are disposed under the latch for returning the latch to its original position; a pressing part is formed by an upper end of the latch which extends outwardly from an upper surface of the handle; a longitudinal slot in communication with the blade receiving slot is disposed at a lower portion of the latch; a fixing block corresponding to the fixing notch of the blade tang is disposed on a bottom surface of the longitudinal slot.

The height of the longitudinal slot is greater than the height of the blade receiving slot.

The fixing block is formed by protruding upwardly from a middle part of the bottom surface of the longitudinal slot.

The latch springs are pagoda springs.

There are two latch springs in total disposed on two sides under the latch, one on each side.

The latch is in the shape of an inverted T, and its sides have a slide fit with the casing at the front end of the handle.

Due to the adoption of the above technical proposals, the present invention has the following advantages over the prior art:

The engagement between the latch on the handle and the fixing notch on the blade allows the handle and the blade of the present invention to be removably assembled, and therefore fulfill the object of replacing blades of different specifications on the same handle. Cost of use will be lower accordingly. Besides, spare blades could be stored in a simple blade container for carrying around, thus enhance convenience of use. Furthermore, to replace the blade, it is only necessary to press down the latch to release the pin of the latch from the fixing notch on the blade tang. Disassembling and assembling of the blade could be achieved easily and quickly.

### BRIEF DESCRIPTION OF THE DRAWINGS

FIG. 1 shows a top view of the press-down type composite putty knife of the present invention.

FIG. 2 shows a partial sectional view along line A-A of FIG. 1.

FIG. 3 shows a structural view of the press-down type composite putty knife of the present invention before assembly.

FIG. 4 shows a structural view of the press-down type composite putty knife of the present invention after assembly.

### DETAILED DESCRIPTION OF THE INVENTION

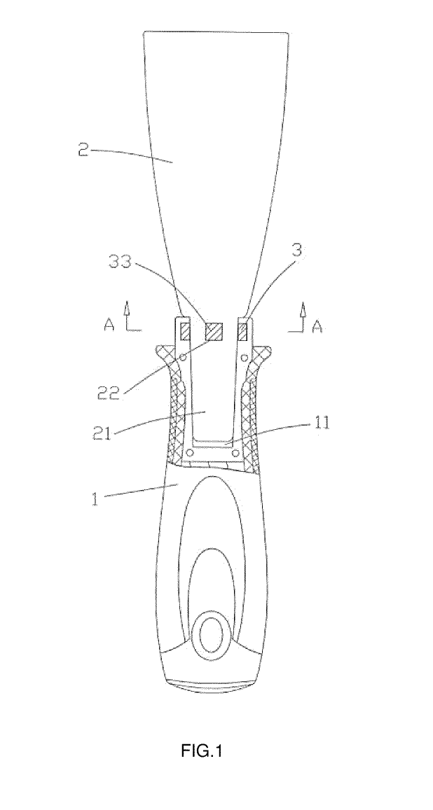

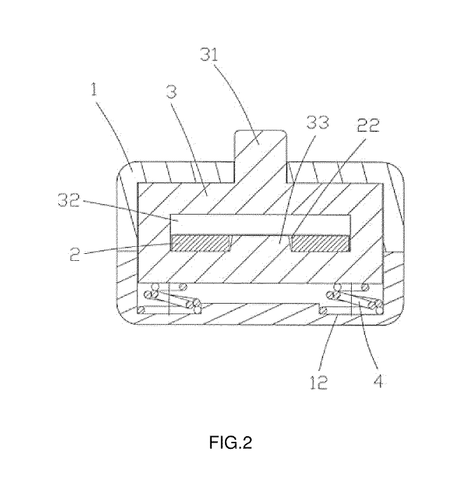

As illustrated in FIGS. 1 and 2, the press-down type composite putty knife of the present invention comprises a handle 1 and a blade 2 with a rear end of the blade 2 inserted into a blade receiving slot 11 at a front end of the handle 1. The rear end of the blade 2 has a blade tang 21 which is provided with a fixing notch 22. The fixing notch 22 can be circular, rectangular, triangular or polygonal in shape. A latch 3 is disposed at the front end of the handle 1 inside its casing. Latch springs 4 are disposed under the latch 3 for returning the latch to its original position. A pressing part 31 is formed by an upper end of the latch 3 which extends outwardly from an upper surface of the handle. A longitudinal slot 32 in communication with the blade receiving slot 11 is disposed at a lower portion of the latch 3. The height of the longitudinal slot 32 is greater than the height of the blade receiving slot 11 to ensure that the longitudinal slot 32 can keep in communication with the blade receiving slot 11 even when the latch 3 is set into motions. A fixing block 33 corresponding to the fixing notch 22 of the blade tang is disposed on a bottom surface of the longitudinal slot 32. The fixing block 33 is formed by protruding upwardly from a middle part of the bottom surface of the longitudinal slot 32. The shape of the fixing block 33 corresponds to the shape of the fixing notch 22.

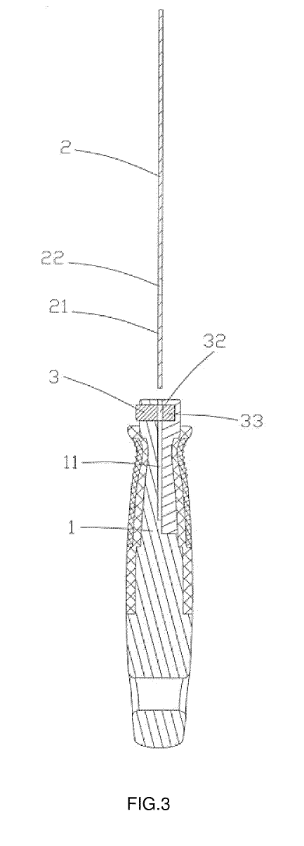

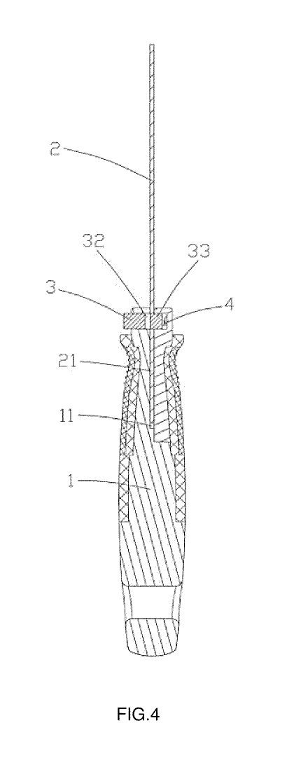

As illustrated in FIGS. 3 and 4, to assemble the blade, press down the latch 3 of the pressing part 31 so that the fixing block 33 on the bottom surface of the longitudinal slot 32 is at a lower position than the blade receiving slot 11, then insert the blade tang 21 into the blade receiving slot 11 at the front end of the handle 1 until the entire blade tang 21 is inserted therein; release the pressing part 31 and the latch 3 will return upwardly to its original position under the effect of the latch springs 4; meanwhile, the fixing block 33 on the bottom surface of the longitudinal slot 32 will engage with the fixing notch 22 on the blade tang 21 and lock the handle 1 and the blade 2 together. To replace the blade, press down the latch 3 to release the fixing block 33 on the bottom surface of the longitudinal slot 32 from its engagement with the fixing notch 22 on the blade tang 21, the original blade can then be removed and replaced by inserting another blade of the desired specification easily.

As illustrated in FIG. 2, there are two latch springs 4 which are pagoda springs. The two latch springs 4 are disposed on two sides under the latch 3, one on each side, so that the latch 3 is more sensitive. The lower ends of the latch springs 4 are disposed in the cavities 12 on the bottom wall of the casing at the front end of the handle 1, with the upper ends of the latch springs 4 pressing against the bottom of the latch 3. Such a structure is reasonably constructed. The latch 3 is in the shape of an inverted T, and its sides have a slide fit with the casing at the front end of the handle 1. The slide fit can ensure reliability of operation by preventing the latch 3 from loosing off when it is being pressed down or returns upwardly to its original position.

What is claimed is:

1. A press-down type composite putty knife which comprises a handle (1) and a blade (2) with a rear end of the blade (2) inserted into a blade receiving slot (11) at a front end of the handle (1), characterized in that the rear end of the blade (2) has a blade tang (21) which is provided with a fixing notch (22); a latch (3) is disposed at the front end of the handle (1) inside its casing; latch springs (4) are disposed under the latch (3) for returning the latch to its original position; a pressing part (31 ) is formed by an upper end of the latch (3) which extends outwardly from an upper surface of the handle; a longitudinal slot (32) in communication with the blade receiving slot (11) is disposed at a lower portion of the latch (3); a fixing block (33) corresponding to the fixing notch (22) of the blade tang is disposed on a bottom surface of the longitudinal slot (32).

2. The press-down type composite putty knife as in claim 1, characterized in that the height of the longitudinal slot (32) is greater than the height of the blade receiving slot (11).

3. The press-down type composite putty knife as in claim 2, characterized in that the fixing block (33) is formed by protruding upwardly from a middle part of the bottom surface of the longitudinal slot (32).

4. The press-down type composite putty knife as in claim 1, characterized in that the latch springs (4) are pagoda springs.

5. The press-down type composite putty knife as in claim 4, characterized in that there are two latch springs (4) in total disposed on two sides under the latch (3), one on each side.

6. The press-down type composite putty knife as in claim 1, characterized in that the latch (3) is in the shape of an inverted T, and its sides have a slide fit with the casing at the front end of the handle (1).
